(19) United States
(12) Patent Application Publication
(10) Pub. No.: US 2023/0362684 A1
(43) Pub. Date: Nov. 9, 2023

(54) METHOD AND APPARATUS TO OPTIMIZE NON-PUBLIC NETWORK (NPN) IN A WIRELESS COMMUNICATION SYSTEM

(71) Applicant: SAMSUNG ELECTRONICS CO., LTD., Suwon-si (KR)

(72) Inventor: Sangbum KIM, Suwon-si (KR)

(21) Appl. No.: 18/311,774

(22) Filed: May 3, 2023

(30) Foreign Application Priority Data
May 3, 2022 (KR) 10-2022-0054768

(51) Int. Cl. H04W 24/02; H04W 48/18; H04W 60/04

(52) U.S. Cl. CPC H04W 24/02; H04W 48/18; H04W 60/04

(57) ABSTRACT

The disclosure relates to a 5G or 6G communication system for supporting a higher data transmission rate. A method performed by a UE in a wireless communication system, the method includes receiving logged MDT configuration information including a list of at least one NPN identity, performing logged MDT for a SNPN based on the logged MDT configuration information, identifying whether an identity of the SNPN selected or registered by the UE matches with the list, transmitting, to a BS, an availability indicator indicating a result of the logged MDT is stored in the UE, in case that the identity of the SNPN selected or registered by the UE matches with the list, receiving, from the BS, a UE information request message, and transmitting, to the BS, a UE information response message including the result of the logged MDT for the SNPN as a response to the UE information request message.

### CROSS-REFERENCE TO RELATED APPLICATION

This application is based on and claims priority under 35 U.S.C. § 119 to Korean Patent Application No. 10-2022-0054768, filed on May 3, 2022, in the Korean Intellectual Property Office, the disclosure of which is incorporated by reference herein in its entirety.

### BACKGROUND

### 1. Field

The disclosure relates to terminal and base station operations in a wireless communication system, and particularly, a method and an apparatus for optimizing a non-public network (NPN).

### 2. Description of Related Art

5^{th} generation (5G) mobile communication technologies define broad frequency bands such that high transmission rates and new services are possible, and can be implemented not only in “Sub 6 GHz” bands such as 3.50 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 9.5 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (m MTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing minWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries. IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 50 baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), Al service support, metaverse service support, and drone communication.

Furthermore, such development of 5G mobile communication systems will serve as a basis for developing not only new waveforms for providing coverage in terahertz hands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

As discussed above, various services may be provided with the advance of the mobile communication system, a solution for effectively providing such services is demanded, and particularly, a solution for optimizing a non-public network (NPN) is demanded.

The disclosed embodiment is to provide an apparatus and a method for effectively providing a service in a wireless communication system.

According to an embodiment of the disclosure, a method performed by a user equipment (UE) in a wireless communication system, the method including receiving logged minimization of drive test (MDT) configuration information including a list of at least one non-public network (NPN) identity, performing logged MDT for a stand-alone NPN (SNPN) based on the logged MDT configuration information, identifying whether an identity of the SNPN selected or registered by the UE matches with the list, transmitting, to a base station (BS), an availability indicator indicating a result of the logged MDT is stored in the UE, in case that the identity of the SNPN selected or registered by the UE matches with the list, receiving, from the BS, a UE information request message, and transmitting, to the BS, a UE information response message including the result of the logged MDT for the SNPN as a response to the UE information request message.

The disclosure provides an apparatus and a method for effectively providing a service in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof; may mean to include, be included within, interconnect with, contain, be contained within, connect to or with, couple to or with, be communicable with, cooperate with, interleave, juxtapose, be proximate to, be bound to or with, have, have a property of, the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. Anon-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates a structure of a next-generation mobile communication system according to an embodiment of the present disclosure;

FIG. 1B illustrate a radio access state transition in the next-generation mobile communication system according to an embodiment of the present disclosure;

FIG. 1C illustrate a technique for collecting and reporting cell measurement information according to an embodiment of the present disclosure;

FIG. 1D illustrate a method for collecting and reporting the cell measurement information according to an embodiment of the present disclosure;

FIG. 1E illustrate a flowchart of operations for collecting and reporting the cell measurement information according to an embodiment of the present disclosure;

FIG. 1F illustrate a visited-standalone non-public network (V-SNPN) according to an embodiment of the present disclosure;

FIG. 1G illustrate an onboarding (O)-SNPN according to an embodiment of the present disclosure;

FIG. 1H illustrate a flowchart of operations for collecting and reporting NPN related information, through logged minimization of drive tests (MDT) according to an embodiment of the present disclosure;

FIG. 1I illustrate a flowchart of terminal operations for collecting and reporting the NPN related information, through the logged MDT according to an embodiment of the present disclosure;

FIG. 1J illustrate a flowchart of base station operations for collecting and reporting the NPN related information, through the logged MDT according to an embodiment of the present disclosure;

FIG. 1K illustrate a flowchart of operations for collecting and reporting the NPN related information, through charging enablement function (CEF) report according to an embodiment of the present disclosure;

FIG. 1L illustrate a flowchart of terminal operations for collecting and reporting the NPN related information, through the CEF report according to an embodiment of the present disclosure;

FIG. 1M illustrate a flowchart of operations for collecting and reporting the NPN related information, through radio link failure (RLF) report according to an embodiment of the present disclosure;

FIG 1N illustrate a flowchart of terminal operations for collecting and. repotting NPN related information, through the RLF report according to an embodiment of the present disclosure;

FIG. 1O illustrate an internal structure of a terminal according to an embodiment of the present disclosure; and

FIG. 1P illustrate a configuration of a base station according to an embodiment of the present disclosure.

### DETAILED DESCRIPTION

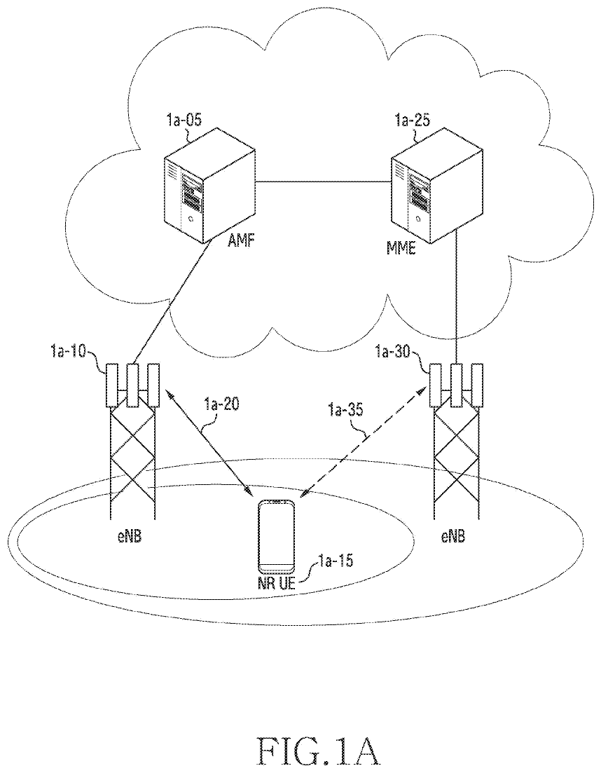

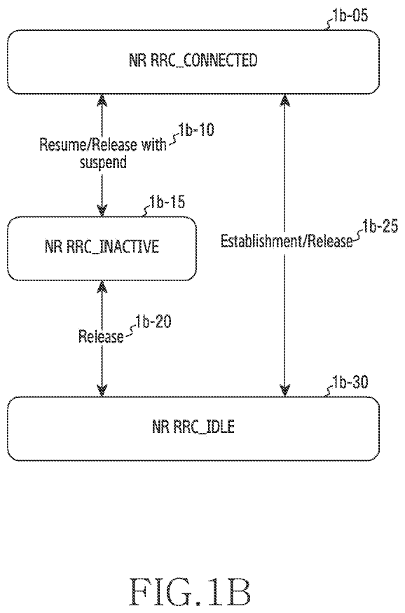

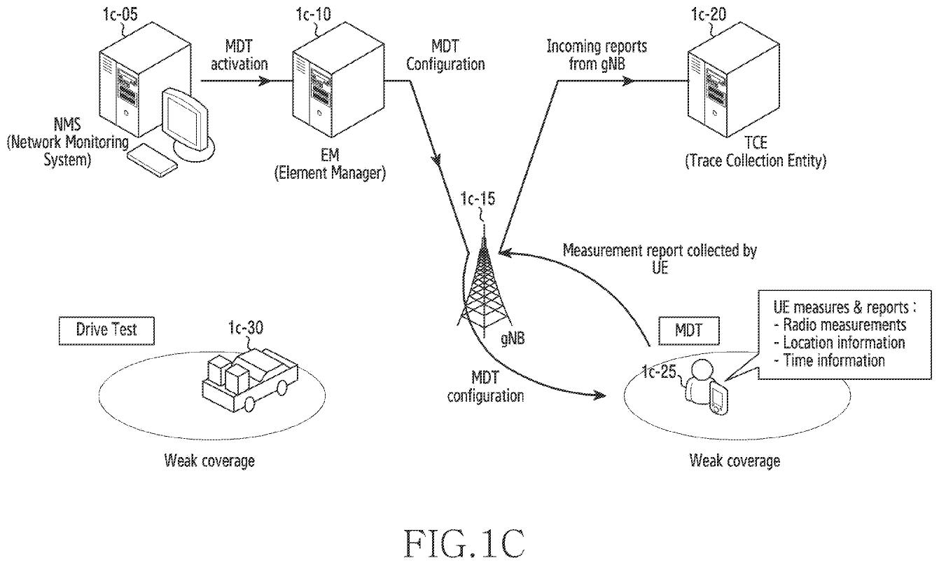

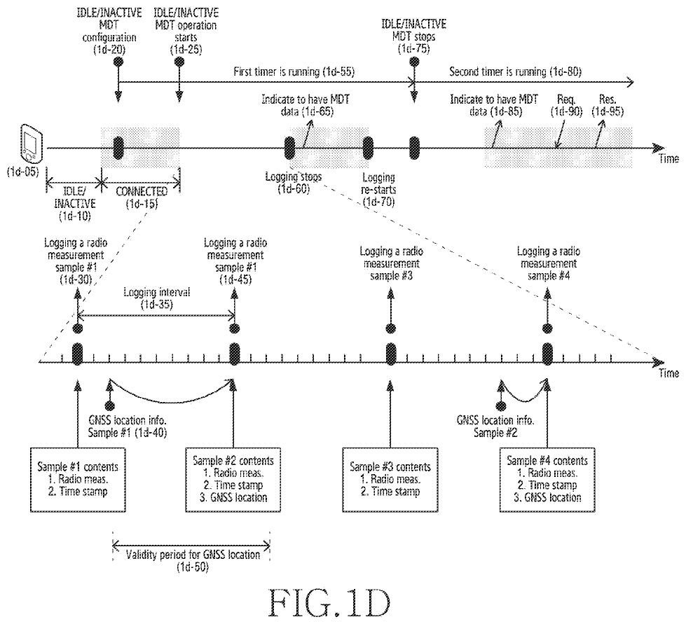

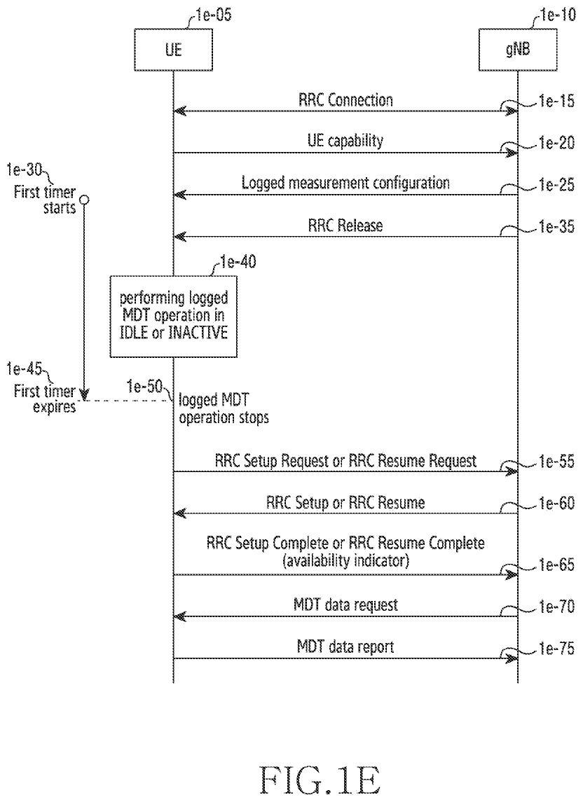

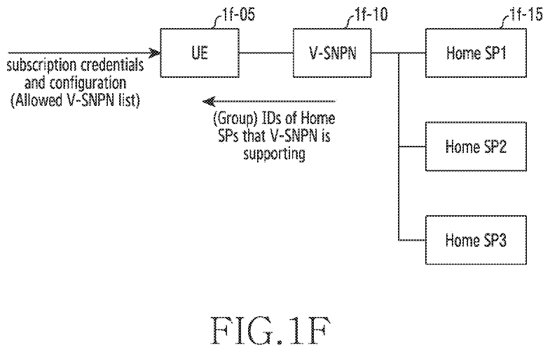

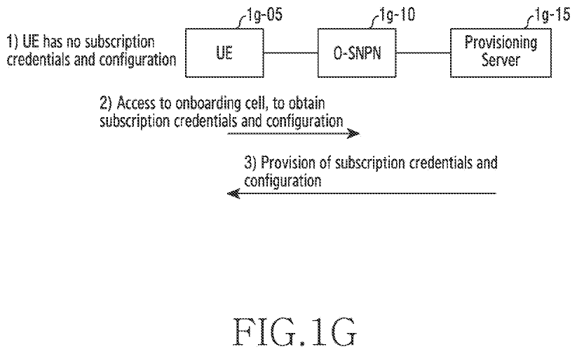

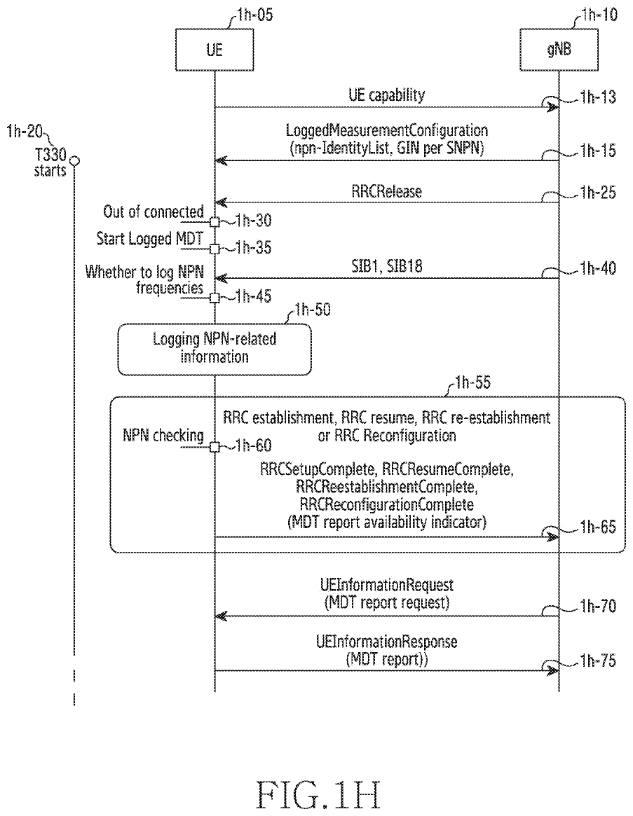

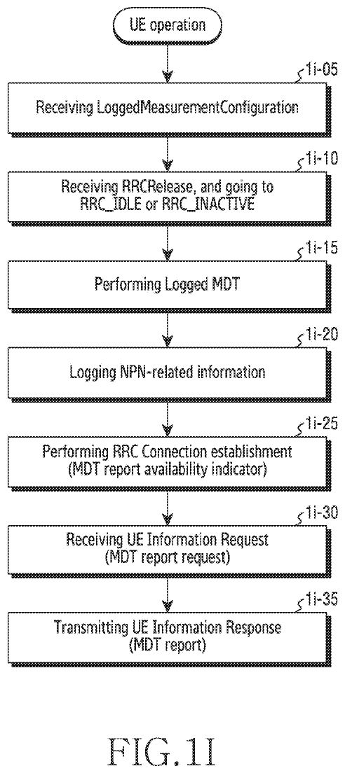

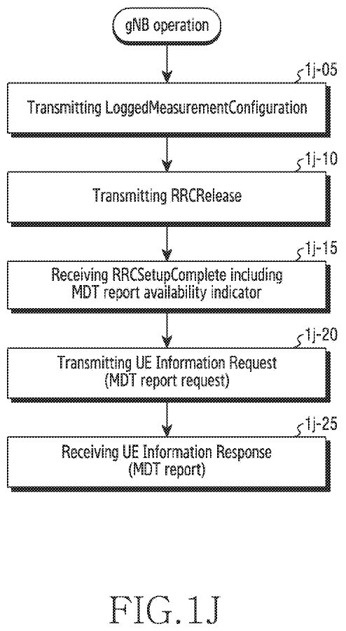

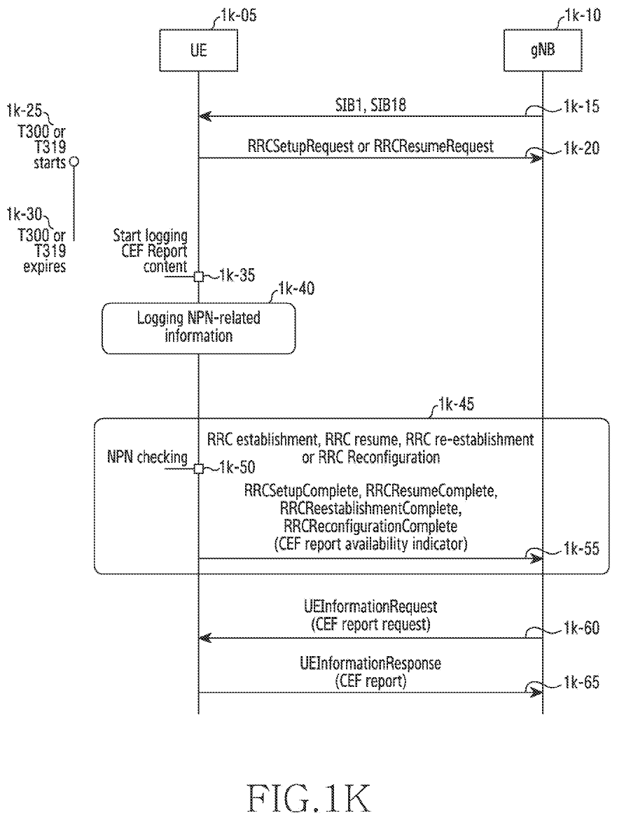

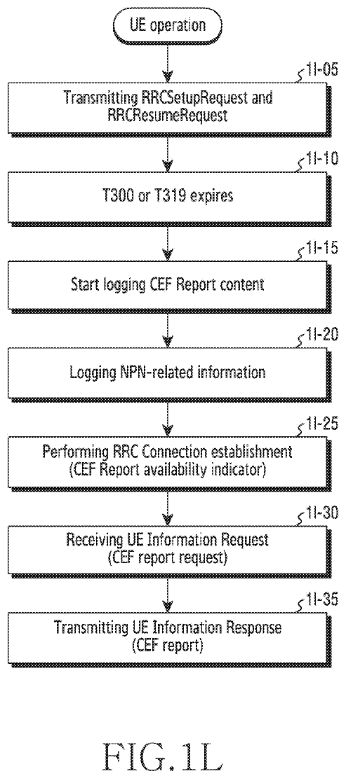

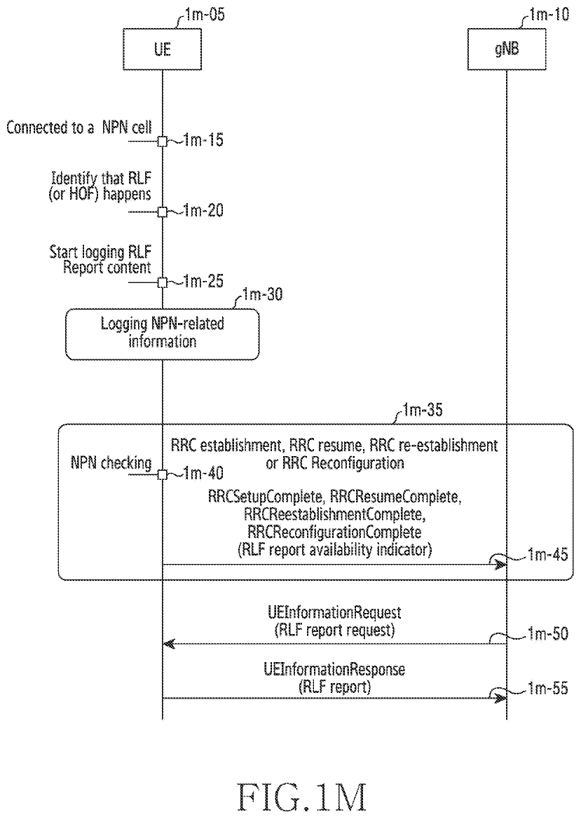

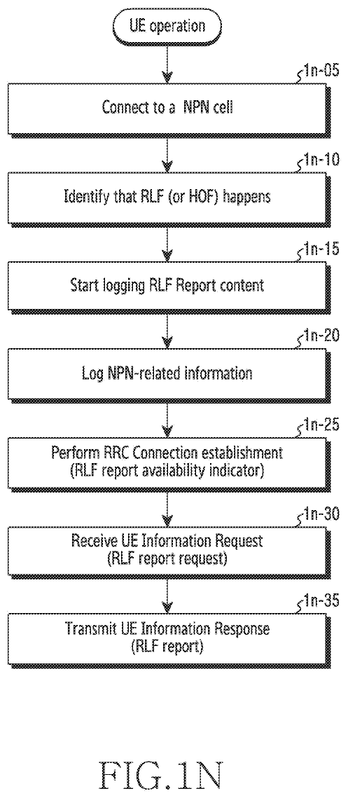

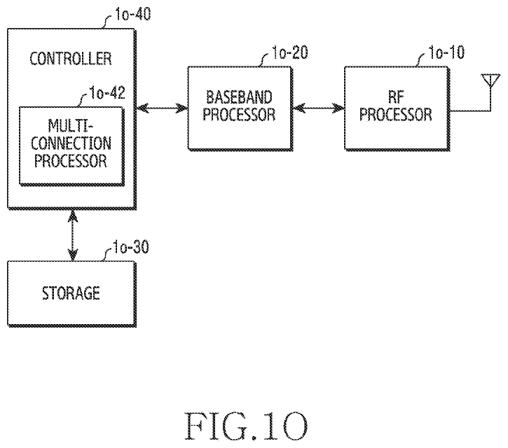

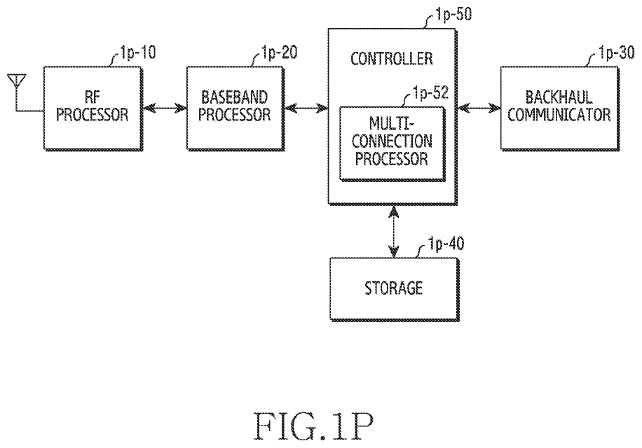

FIGS. 1A through 1P, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, in describing the disclosure, a detailed description of a related known function or configuration will be omitted if it is deemed to make the gist of the disclosure unnecessarily vague. Terms to be described hereafter have been defined by taking into consideration functions in the disclosure, and may be different depending on a user or an operator's intention or practice. Accordingly, they should be defined based on contents over the entire specification. In the following, embodiments of the disclosure are described in detail with reference to the accompanying drawings.

Advantages and features of the disclosure, and methods for achieving them will be clarified with reference to embodiments to be described below in detail together with the accompanying drawings. However, the disclosure is not limited to the embodiments disclosed below but may be implemented in various different forms, the embodiments are provided to only complete the scope of the disclosure and to allow those skilled in the art to which the disclosure pertains to fully understand a category of the disclosure, and the disclosure is solely defined within the scope of the claims. The same reference numeral refers to the same element throughout the specification.

At this time, it will be understood that each block of the process flowchart illustrations and combinations of the flowchart illustrations may be executed by computer program instructions. Since these computer program instructions may be mounted on a processor of a general purpose computer, a special purpose computer or other programmable data processing apparatus, the instructions executed by the processor of the computer or other programmable data processing equipment may generate means for executing functions described in the flowchart block(s). Since these computer program instructions may also be stored in a computer-usable or computer-readable memory which may direct a computer or other programmable data processing equipment to function in a particular manner, the instructions stored in the computer-usable or computer-readable memory may produce a manufacture article including instruction means which implement the function described in the flowchart block(s). Since the computer program instructions may also be loaded on a computer or other programmable data processing equipment, a series of operational steps may be performed on the computer or other programmable data processing equipment to produce a computer-executed process, and thus the instructions performing the computer or other programmable data processing equipment may provide steps for executing the functions described in the flowchart block(s).

In addition, each block may represent a portion of a module, a segment or code which includes one or more executable instructions for implementing a specified logical function(s). Also, it should be noted that the functions mentioned in the blocks may occur out of order in some alternative implementations. For example, two blocks shown in succession may in fact be executed substantially concurrently or the blocks may sometimes be executed in the reverse order depending on corresponding functionality.

At this time, the term “˜unit” as used in the present embodiment indicates software or a hardware component such as a field programmable gate array (FPGA) or an application-specific integrated circuit (ASIC), and “˜unit” performs specific roles. However, “˜unit” is not limited to software or hardware. “˜unit” may be configured to reside on an addressable storage medium and configured to reproduce on one or more processors. Accordingly, “˜unit” may include, for example, components such as software components, object-oriented software components, class components and task components, processes, functions, attributes, procedures, sub-routines, segments of program code, drivers, firmware, microcode, circuitry, data, databases, data structures, tables, arrays, and variables. The functionalities provided in the components and “˜unit” may be combined to fewer components and “˜units” or may be further separated into additional components and “˜units/” Further, the components and “˜units” may be implemented to reproduce one or more central processing units (CPUs) within a device or a security multimedia card. Also, “˜unit” in the embodiment may include one or more processors.

In the following description of the disclosure, a detailed description of well-known functions or elements associated with the disclosure will be omitted if it is deemed to unnecessarily obscure the subject matter of the disclosure. Hereinafter, embodiments of the disclosure will be described with reference to the accompanying drawings.

Terms for identifying access nodes, terms indicating network entities, terms indicating messages, terms indicating interfaces between network entities, and terms indicating various identification information used in the following description are illustrated only for convenience of description. Accordingly, the disclosure is not limited to the terms to be described, and other terms having the same technical meaning may be used.

In the following description, a physical channel and a signal may be used. interchangeably with data or a control signal. For example, a physical downlink shared channel (PDSCH) is a term indicating a physical channel carrying data, but the PDSCH may be also used to indicate the data. That is, in the disclosure, an expression “transmitting the physical channel” may be interpreted equivalently to an expression “transmitting data or a signal through the physical channel.”

Hereinafter, in the disclosure, higher signaling indicates a signal transmission method transmitted from a base station to a terminal using a downlink data channel of a physical layer, or from a terminal to a base station using an uplink data channel of the physical layer. The higher signaling may be understood as radio resource control (RRC) signaling or a media access control (MAC) control element (CE).

Hereinafter, for convenience of description, the disclosure employs terms and names defined in 3rd generation partnership project (3 GPP) new radio (NR) or 3 GPP long term evolution (LTE) standard. However, the disclosure is not limited by such terms and names, and may be equally applied to systems conforming to other standards. In the disclosure, a next generation node B (gNB) may be used interchangeably with an evolved NodeB (eNB). That is, a base station described as the eNB may indicate the gNB. In addition, a term “terminal” may indicate not only a cellular phone, a machine type communication (MTC) device, a narrowband (NB)-internet of things (IoT) device, and a sensor but also other wireless communication devices.

Hereafter, the base station, which is an entity for perforating resource allocation of the terminal, may be at least one of a gNB, an eNB, a NodeB, a base station (BS), a radio access unit, a base station controller, or a node on the network. The terminal may include a user equipment (UE), a mobile station (MS), a cellular phone, a smartphone, a computer, or a multimedia system for executing a communication function. Notably, the disclosure is not limited to those examples.

In particular, the disclosure may be applied to the 3 GPP NR (5th generation (5G) mobile communication standard). The disclosure may be applied to intelligent services based on the 5G communication and IoT related technologies (e.g., smart home, smart building, smart city, smart car or connected car, health care, digital education, retail, security and safety services, etc.). In the disclosure, the eNB may be used interchangeably with the gNB to ease the explanation. That is, the base station described as the eNB may indicate the gNB. Also, the term “terminal” may indicate other wireless communication devices as well as a mobile phone, NB-IoT devices, and sensors.

A wireless communication system is evolving from its early voice-oriented service to, for example, a broadband wireless communication system which provides high-speed, high-quality packet data services according, to communication standards such as high speed packet access (HSPA) of 3 GPP, LTE or evolved universal terrestrial radio access (E-UTRA), LTE-advanced (A), LTE-Pro, high rate packet data (HRPD) of 3 GPP2, ultra mobile broadband (UMB), and institute of electrical and electronics engineers (IEEE) 802.16e.

As a representative example of the broadband wireless communication system, the LTE system employs an orthogonal frequency division multiplexing (OFDM) scheme in a downlink (DL), and a single carrier frequency division multiple access (SC-FDMA) scheme in an uplink (UL). The UL indicates a radio link through which the UE or the MS transmits data. or a control signal to the eNB or the BS, and the DL indicates a radio link through which the eNB transmits data or a control signal to the UE. A multi-access scheme distinguishes data or control information of each user by assigning and operating time-frequency resources for carrying the data or the control information of each user not to overlap, that is, to establish orthogonality.

A future communication system after the LTE, that is, the 5G communication system, which should be able to freely reflect various requirements of users and service providers, needs to support a service for simultaneously satisfying various requirements. Services considered for the 5G communication system include enhanced mobile broadband (eMBB), massive MTC (mMTC), ultra reliability low latency communication (URLLC) and so on.

According to an embodiment, the eMBB aims to provide a faster data rate than a data rate supported by existing LTE, LTE-A or LTE-Pro. For example, the eMBB in the 5G communication system should be able to provide a peak data rate of 20 gigabits per second (Gbps) in the DL and 10 Gbps in the UL in terms of one base station. In addition, the 5G communication system should provide the peak data rate and concurrently provide an increased user perceived data rate of the terminal. To satisfy these requirements, improvements of various transmission and reception technologies are required, including a further advanced multi input multi output (MIMO) transmission technology, In addition, while signals are transmitted using a maximum 20 megahertz (MHz) transmission bandwidth in a 2 GHz band used by the LTE, the 5G communication system uses a frequency bandwidth wider than 20 MHz in the frequency hand of 3-6 GHz or 6 GHz or higher, thus satisfying the required data rate in the 5G communication system.

At the same time, the 5G communication system is considering the mMTC to support application services such as IoT. The mMTC requires large-scale terminal access support in a cell, terminal coverage enhancement, improved battery time, and terminal cost reduction to efficiently provide the IoT. The loT is attached to various sensors and various devices to provide communication functions and accordingly should be able to support a great number of terminals (e.g., 1,000,000 terminals/km2) in the cell. In addition, the terminal supporting the mMTC is highly likely to be located in a shaded area not covered by the cell such as a basement of building due to its service characteristics, and thus may require wider coverage than other services provided by the 5G communication system, A terminal supporting the mMTC should be configured with a low-priced terminal, and may require a quite long battery lifetime such as 10˜15 years because it is difficult to frequently replace the battery of the terminal.

Finally, the URLLC is a cellular-based wireless communication service used for mission-critical purposes, and may be used for robot or machinery remote control, industrial automation, unmanaged aerial vehicle, remote health care, emergency alert, or the like. Thus, the communication provided by the URLLC should provide very low latency (ultra low latency) and very high reliability (ultra high reliability). For example, a service supporting the URLIX should meet air interface latency smaller than 0.5 milliseconds and at the same time has requirements of a packet error rate below 10⁻⁵. Hence, for the service supporting the URLLC, the 5G system should provide a transmit time interval (TTI) smaller than other services, and concurrently requires design issues for allocating a wide resource in the frequency band to obtain communication link reliability.

The three services of the 5G communication system, that is, the eMBB, the URLLC, and the mMTC may be multiplexed and transmitted in one system. In this case, to satisfy the different requirements of the respective services, different transmission and reception schemes and transmission and reception parameters may be used between the services, Notably, the aforementioned mMTC, the URLLC, and the URLLC 5G are merely examples of the different service types, and the service type according to the disclosure is not limited to those examples.

In addition, embodiments of the disclosure are explained with the LTE, LTE-A, LTE Pro or 5G (or NR, or the next-generation mobile communication) as an example, but the embodiments of the disclosure may be applied to other communication systems having similar technical backgrounds or channel forms. In addition, the disclosure may also be applied to other communication systems through some modifications without significantly departing from the range of the disclosure based on determination of those skilled in the technical knowledge.

FIG 1A illustrates a structure of a next-generation mobile communication system according to an embodiment of the present disclosure.

Referring to FIG. 1A, a radio access network of the next-generation communication system (NR) may include, but not limited to, a NR node B (gNB) 1a-10 and an NR core network, and the NR core network may include, but not limited to, an access management function (AMF) 1a-05 as shown in FIG. 1A. An NR UE or UE 1a-15 may access an external network via the gNB 1a-10 and the AMF 1a-05.

In FIG. 1A, the gNB 1a-10 may correspond to the eNB of the existing LTF system. The gNB 1a-10 is connected to the NR. UE 1a-15 over a radio channel and may provide a more advanced service than that of the existing Node B (LTE base station), as indicated by 1a-20. Since even user traffic is served through a shared channel in the next-generation mobile communication system, a device for collecting state information of UEs such as buffer status, available transmission power state, and channel state, and performing scheduling is required, which may be managed by the gNB 1a-10. One gNB may generally control a plurality of cells. To realize ultra high-speed data transmission compared to the existing LTE system, the next-generation mobile communication system may have a maximum bandwidth greater than the existing maximum bandwidth, and employ a beamforming technique in addition to the OFDM as the radio access technique.

According to an embodiment of the disclosure, the gNB 1a-10 may apply adaptive modulation & coding (AMC) which determines a modulation scheme and a channel coding rate based on the UE channel state.

According to an embodiment of the disclosure, the AMF 1a-05 may perform functions such as mobility support, bearer setup, quality of service (QoS) setup. The AMF 1a-05 manages various control functions as well as a mobility management function for the UE, and may be connected with a plurality of gNBs. The next-generation mobile communication system may also interwork with the existing LYE system, and the AMF 1a-05 may be connected to a mobility management entity (MME) 1a-25 through a network interface. The MME 1a-25 may be connected with an eNB 1a-30 which is an existing base station. The UE supporting LTE-NR dual connectivity may transmit and receive data, while maintaining connection with the eNB 1a-30 as well as the gNB 1a-10, as indicated by 1a-35.

FIG. 1B illustrates a radio access state transition in the next-generation mobile communication system according to an embodiment of the present disclosure.

The next-generation mobile communication system as three RRC states. A connected mode RRC CONNECTED 1b-05 may be an RRC state in which the UE may transmit and receive data. An idle mode RRC IDLE 1b-30 may be an RRC state in which the UE monitors whether paging is transmitted to the UE. The connected mode 1b-05 and the idle mode 1b-30 are the RRC states applied to the existing LTE system, and detailed descriptions thereof are the same as those of the existing LTE system. The next-generation mobile communication system defines an inactive mode RRC INACTIVE 1b-15 as a new RRC state. In the inactive mode 1b-15 RRC state, UE context is maintained in the gNB and the UE, and radio access network (RAN) based paging may be supported. Characteristics of the inactive RRC state are described, but not limited to, as below:
Cell re-selection mobility;
CN-NR RAN connection (both C/U-planes) has been established for UE;
The UE AS context is stored in at least one gNB and the UE;
Paging is initiated by NR RAN;
RAN-based notification area is managed by NR RAN; and/or
NR RAN knows the RAN-based notification area which the UE belongs to.

According to an embodiment of the disclosure, the inactive mode 1b-15 RRC state may switch to the connected mode or the idle mode, by using a particular procedure. The transition from the inactive mode 1b-15 to the connected mode 1-05 may be performed according to an RRC resume process, and the transition from the connected mode 1b-05 to the inactive mode 1b-15 may be performed by using a release procedure including suspend configuration information, as indicated by 1b-10. The aforementioned procedure may include a procedure of transmitting and receiving one or more RRC messages between the UE and the gNB, and may include one or more steps. The transition from the inactive mode 1b-15 to the idle mode 1b-30 is possible, through a release procedure 1b-20 after the RRC resume. The transition between the connected mode and the idle mode may conform to the existing LTE technology. That is, through an establishment or release procedure 1b-25, the transition between the RRC states (three modes) may be performed.

FIG. 1C illustrates a technique for collecting and reporting cell measurement information according to an embodiment of the present disclosure.

According to an embodiment of the disclosure, in network deployment or optimization, a mobile communication service provider may typically measure a signal strength in an expected service area, and deploy or rearrange base stations in the service area based on the measured signal strength. The service provider may load a signal measurement equipment on a vehicle and collect cell measurement information in the service area, which requires considerable time and cost. The process of loading the signal measurement equipment on the vehicle and collecting the cell measurement information in the service area generally utilizes a vehicle, and accordingly is referred to as a drive test, The UE is equipped with a function for measuring a signal from the gNB, to support operations such as cell reselection or handover, and serving cell addition if migrating between cells.

Hence, instead of the drive test, a UE in the service area may be used, which is referred to as minimization of drive test (MDT). The service provider may set an MDT operation to specific UEs, through various devices of the network, and the UEs may collect and store signal strength information from a serving cell and neighboring cells in the connected mode RRC_Connected, the idle mode RRC_Idle or the inactive mode RRC_Inactive. Besides, the UEs may also store various information such as location information, time information and signal quality information. The stored information may be reported to the network if the UEs are in the connected mode, and the reported information may be transmitted to a specific server.

According to an embodiment of the disclosure, the MDT operation may be divided largely into immediate MDT and logged MDT. The immediate MDT may be an operation in which the UE reports the collected information immediately to the network. Since the UE may immediately report the collected information, only the connected mode terminal may perform the immediate MDT. The immediate MDT generally reuses an RRM measurement process for supporting operations such as handover and serving cell addition, and location information, time information, and the like may be additionally reported.

The logged MDT may be an operation in which the collected information is not immediately reported to the network, and after the UE switches to the connected mode, the stored information is reported. The UE in the idle mode which may not immediately report to the network may perform the logged MDT. The UE in the inactive mode introduced in the next-generation mobile communication system may perform the logged MDT. If a specific UE is in the connected mode, the network may provide the UE with configuration information for performing the logged MDT operation, and the UE may collect and store the configured information after switching to the idle mode or the inactive mode.

TABLE 1

| | RRC state |
|---|---|
| Immediate MDT | RRC_Connected |
| Logged MDT | RRC_Idle, RRC_Inactive |

FIG. 1D illustrates a method for collecting and reporting the cell measurement information according to an embodiment of the present disclosure.

A UE 1d-05 may switch from an idle mode or an inactive mode 1d-10 to a connected mode 1d-15. The UE 1d-05 may collect and report MDT data to the gNB in the connected mode, through the immediate MDT operation. The UE 1d-05 switched to the connected mode may receive from the gNB logged MDT configuration information 1d-20 performed in the idle mode or the inactive mode. The logged MDT configuration information is contained in a specific RRC message and transmitted to the UE 1d-05, and the UE 1d-05 receiving the RRC message may drive a first timer in operation 1d-55. The UE 1d-05 may perform the logged MDT operation in the idle mode or the inactive mode period, until the first timer expires. A value of the first timer may be included in the logged MDT configuration information. If the UE 1d-05 switches to the idle mode or the inactive mode, the UE may perform the logged MDT according to the received configuration information in operation 1d-25. The UE 1d-05 may store specific information collected at intervals, that is, at logging intervals 1d-35, in operations d-30 and Id-45. In addition, if collecting valid location information 1d-40, the UE 1d-05 may need to store the valid location information. Whether the location information is valid may be determined to he valid if a specific time 1d-50 does not pass, after the location information is collected. The specific time may he shorter than or equal to the logged interval.

Even before the first timer expires, the UE 1d-05 may temporarily stop the logged MDT operation which has been performed if switching to the connected mode, in operation 1d-60. However, the first timer is continuously operated without stopping even in the connection mode period. That is, the first timer may continue to operate regardless of the RRC state change. Notably, the first timer may be stopped, if a terminal memory for storing the MDT data is insufficient and accordingly no more storage is available, or if the logged MDT configuration information is released. Releasing the logged MDT configuration information may correspond to, but not limited to, providing other logged MDT configuration information from a serving radio access technology (RAT) or another RAT, or detaching or turning off the UE 1d-05.

During RRC connection establishment or RRC connection resume, the UE 1d-05 may report its collected information (MDT data) stored therein to the gNB, using an RRC setup complete message or an RRC resume complete message, in operation id-65.

The RRC connection establishment may include switching the UE 1d-05 from the idle mode to the connected mode. The RRC connection establishment generally includes, but not limited to, three steps, and use, but not limited to, three types of the RRC message as follows:
Step 1: The UE transmits an RRC Setup Request message to the gNB;
Step 2: The gNB transmits an RRC Setup message to the UE; and
Step 3: The UE transmits an RRC Setup Complete message to the gNB.

The RRC connection resume may switch the UE from the inactive mode to the connected mode. The RRC connection resume may generally include, but not limited to, three steps, and use, but not limited to, three types of the RRC message as follows:
Step 1: The UE transmits an RRC Resume Request message to the g
Step 2: The gNB transmits an RRC Resume message to the UE; and
Step 3: The UE transmits an RRC Resume Complete message to the gNB.

The UE 1d-05 may report information indicating the collected information to a target gNB even during RRC connection reestablishment and a handover procedure, in addition to the RRC connection establishment or the RRC connection resume. If the logged MDT has been configured but there is no information collected and stored, the report may be omitted. The gNB receiving the report may request, if necessary, a report of the MDT data (i.e., the collected information) stored in the UE 1d-05. The UE 1d-05 may need to continuously store unreported MDT data for a specific time. If the UE 1d-05 returns to the idle mode or the inactive mode and the first timer is not expired, the UE 1d-05 may re-start the logged MDT operation in operation 1d-70. If the first timer expires, the UE 1d-05 may stop the logged MDT operation in operation 1d-75. The UE 1d-05 stopping the logged MDT operation may drive a second tinier in operation 1d-80, and maintain the stored MDT data until the second timer expires.

After the second timer expires, whether to delete the stored MDT data is determined by implementation of the terminal. A value of the second timer may be included in the logged MDT configuration information, or may be not configured to apply a predefined value. If the UE 1d-05 is switched back to the connected mode, the UE 1d-05 may report its collected information (MDT data) stored therein to the gNB in operation 1d-85. The gNB may requests the report of MDT data stored in the UE 1d-05, using a specific RRC message in operation 1d-90. Hence, the UE 1d-05 may include the MDT data stored into a specific RRC message, and report the specific message to the gNB in operation 1d-95.

FIG. 1E illustrates a flowchart of operations for collecting and reporting the cell measurement information according to an embodiment of the present disclosure.

According to an embodiment of the disclosure, a UE 1e-05 may establish a connection with a gNB 1e-10 in operation 1e-15. The UE 1e-05 may provide UE capability information to the gNB 1e-10 in operation 1e-20, and may provide information related to whether the UE 1e-05 supports the MDT operation and which frequency may be measured. The gNB 1e-10 may include configuration information required for performing the logged MDT operation into a specific RRC message, and transmit the RRC message to the UE 1e-05 in operation 1e-25. For example, the configuration information required for performing the logged MDT operation may include, but not limited to, at least one of the following information:
trace reference information;
trace recording session reference information;
trace collection entity (TCE) ID information: The gNB transmits MDT data information reported from the UE, to a data server designated by a ICE ID;
absolute time information: The absolute time information may include an absolute time of a current cell which provides the logged MDT configuration information;
area configuration: The area configuration information is area information for collecting and storing measurement information, through the logged MDT operation, and is indicated on a cell basis. In addition, the area configuration information may include RAT information for collecting the measurement information. A list included in the RAT information may be a blacklist or a whitelist. If the list is the blacklist, the UE collects cell measurement information for a RAT not included in the list. If the list is the whitelist, the UE does not collect cell measuretnent information of a RAT not included in the list;
logging duration: The logging duration information is the value of the first timer, and if the first timer is operating, the logged MDT operation is performed in the idle mode or the inactive mode;
logging interval: An interval of storing the collected information;
plmn-IdentityList (i.e., MDT public land mobile network (PLMN) list): It is PLMN list information, and the pimn-IdentityList information may contain PLMN information for performing not only performing the logged MDT operation hut also the MDT data storing report and the MDT data report. That is, if a registered (RPLMN) of the serving cell matches at least one PLMN of PLMNs of plmn-IdentityList, the UE receiving the plum-IdentityList information may collect MDT measurement results in the corresponding cell or report the collected MDT measurement results;
indicator indicating whether the logged MDT operation is performed in the idle mode, the inactive mode, or both: The indicator may indicate whether the logged MDT operation is performed in the idle mode, the inactive mode, or both, the UE may indicate the RRC state for performing the logged MDT operation, or the UE may define that the logged MDT operation is performed always in the idle mode and the inactive mode, without the indicator indicating whether the logged MDT operation is performed in the idle mode, the inactive mode, or both. The UE may perform the logged MDT operation only in the RRC state indicated by the indicator indicating whether the logged MDT operation is performed in the idle mode, the inactive mode, or both:
indicator indicating whether to collect and store beam level measurement information: The next-generation mobile communication system may employ a beam antenna. Without the indicator indicating whether to collect and store the beam level measurement information, it may be defined that the beam level measurement is always collected and stored for a frequency at which a beam-based operation is performed;
information of a maximum number of beams collected or stored, and information of a minimum signal strength of the beam stored: The UE may skip storing information of a weaker beam than the minimum signal strength of the stored beam. If all beams are weaker than the configured minimum signal value, the UE may store information of one beam information having the greatest signal strength among them, or may include an indicator indicating that all the beams are weaker than the configured minimum signal value.

The UE 1e-05 receiving the logged MDT configuration information may drive the first timer in operation 1e-30. The value of the first timer may be configured to be equal to a value of the logging duration. The gNB 1e-10 may switch the UE 1e-05 to the idle mode or the inactive mode, using an RRC release message in operation 1e-35. Depending on the RRC state for the transition, the RRC release message may contain configuration information for the operation in the RRC state. If the first timer is driving, the UE 1e-05 may perform the logged MDT in the idle mode or the inactive mode in operation 1e-40. The UE 1e-05 measures signal strengths of a serving cell and neighboring cells, and obtains location information. If beam level measurement is configured, the UE 1e-05 may collect and store a signal strength value of a beam greater than the configured minimum value in the serving cell and the neighboring cell. The maximum number of beams to store may be configured or predefined. The signal strength may indicate a reference signal received power (RSRP), a reference signal received quality (RSRQ), or a signal to noise and interference ratio (SINK). The UE 1e-05 may store the collected information at logged intervals. If the first timer expires in operation 1e-45, the UE 1e-05 may stop the logged MDT operation in operation 1e-50.

If the UE 1e-05 is in the idle mode or the inactive mode according to the RRC release message, and receives a RAN or CN paging from the gNB 1e-10 or activates MO (mobile originated) data transmission, the UE 1e-05 may initialize the establishment procedure or the resume procedure for the transition from the idle mode or the inactive mode to the connected mode.

The establishment procedure or the resume procedure may include:
Step 1: The UE transmits an RRC Setup Request message or an RRC Resume Request message to the gNB (operation 1e-55);
Step 2: The gNB transmits an RRC Setup message or an RRC Resume message to the UE (operation 1e-60); and
Step 3: The UE transmits an RRC Setup Complete message or an RRC Resume Complete message to the gNB (operation 1e-65).

The UE 1e-05 may include the indicator indicating whether the MDT data is stored therein, into the RRC setup complete or RRC resume complete message. The gNB 1e-10 receiving the RRC setup complete message may, if necessary, request an MDT data report, using a specific RRC message, that is, UEInformationRequest in operation 1e-70. The UE 1e-05 receiving the MDT data report request may report the MDT data, using a specific RRC message, that is, UEInformationResponse in operation 1e-75.

FIG. 1F illustrates a visited (V)-stand-alone non-public network S(NPN) according to an embodiment of the present disclosure.

The Rel-16 NR mobile communication system has been improved to support a non-public network (NPN). The NPN is largely divided into a closed access group (CAG) and an SNPN. The CAG is also referred to as a public network integrated NPN (PNI-NPN), and indicates an NPN deployed by utilizing a public network provided by the mobile communication service provider. To indicate the PNI-NPN, the gNB may broadcast system information block (SIB)1 including a PNI-NPN ID.

The PNI-NPN ID may include a PLMN ID and a CAG ID, and the PLMN ID may indicate one ID of the PLMNs of the mobile communication service provider which provides the cell.

By contrast, the SNPN may indicate an NPN not associated with the network provided by the mobile communication service provider. To indicate the SNPN, the gNB may broadcast the SIB1 including an SNPN ID. The SNPN ID may include the MAIN ID and a network identity (NID), and the PLMN ID and NID may be irrelevant to the mobile communication service provider. The UE may be set to an SNPN mode, wherein a normal cell reselection operation is not conducted. If the SNPN mode is not set, the UE may perform the normal cell reselection operation while camping on an SNPN cell.

According to an embodiment of the disclosure, the UE obtains in advance NPN information to access, and determines whether to access the cell by considering the PNI-NPN or the SNPN ID broadcast in the SIB1.

In the present disclosure, the SNPN may support an external service provider. In the disclosure, this is referred to as a home service provider (SP) 1f-15 or a credential holder (CH). For example, to wirelessly control a smart factory, an SNPN network may be built. Workers working in the smart factory may wish to receive a service from an external service provider through the SNPN network. The external service provider may be an existing wired/wireless communication service provider, In this case, the AMF and a session management function (SMF) in the SNPN of the smart factory may be connected to network entities of the external service provider to interconnect a user and the external service provider. The SNPN is referred to as a V-SNPN 1f-10. The V-SNPN 1f-10 may broadcast (group) ID information of its home SP using system information. The ID information of the home SP is referred to as group IDs for network selection (GIN). The GIN may include the PLMN ID and the NID, and is provided to UEs through SIB18 which is new system information. The SIB18 extracted from technical specification (TS)38.331 is as follows.

TABLE 2
SIB18 information element

```
              -- ASN1START
            -- TAG-SIB18-START
          SIB18-r17 ::= SEQUENCE {
  gin-ElementList-r17 SEQUENCE (SIZE (1..maxGIN-r17)) OF GIN-Element-r17
            OPTIONAL, -- Need R
  ginsPerSNPN-List-r17 SEQUENCE (SIZE (1..maxNPN-r16)) OF GINs-perSNPN-r17
            OPTIONAL, -- Need R
    lateNonCriticalExtension OCTET STRING OPTIONAL,
                ...
                }
      GIN-Element-r17 ::= SEQUENCE {
        plmn-Identity-r17 PLMN-Identity,
    nid-List-r17 SEQUENCE (SIZE (1..maxGIN-r17)) OF NID-r16
                }
      GINs-perSNPN-r17 ::= SEQUENCE {
supportedGINs-r17 BIT STRING (SIZE (1..maxGIN-r17)) OPTIONAL -- Need R
                }
            -- TAG-SIB18-STOP
              -- ASN1STOP
```

TABLE 3
SIB18 field descriptions

gin-ElementList
The GIN-ElementList contains one or more GIN elements. Each GIN element contains either one
GIN, which is identified by a PLMN ID and a NID, or multiple GINs that share the same PLMN
ID. The GIN index m is defined as d1 + d2 + . . . + d(n − 1) + i for the GIN included in the n-th entry of
the gin-ElementList and the i-th entry of its corresponding GIN-Element, where d(k) is the
number of GIN index values used in the k-th gin-ElementList entry.
ginsPerSNPN-List
Indicates the supported GINs for each SNPN. The network includes the same number of entries
as the number of SNPNs in snpn-AccessInfoList in provided in SIB1, and the n-th entry in this
list corresponds to the n-th SNPN listed in snpn-AccessInfoList provided in SIB1. It is not
present if there is only a single SNPN in snpn-AccessInfoList in SIB1, as in that case all GINs in
this SIB is associated with that SNPN.

TABLE 4
GINs-PerSNPN field descriptions

supportedGINs
Indicates the GINs which are supported by the given SNPN. The first/leftmost bit corresponds to
the GIN with GIN index 0, the second bit corresponds to the GIN with GIN index 1 and so on. A
bit set to 1 indicates that the GIN is supported by the SNPN. If the field is is not present, then the
corresponding SNPN does not support any GINs.

A UE 1f-05 receiving the system information may determine whether to access the V-SNPN, using specific configuration information obtained in advance. In the disclosure, the access of the UE 1f-05 to the V-SNPN is referred to as a credential access or an external CH access in the sense of the access using the credential. For example, V-SNPN list information allowed the access may be included in specific configuration information (subscription credentials and configuration).

FIG. 1G illustrates an onboarding (O)-SNPN according to an embodiment of the present disclosure.

As mentioned earlier, the UE which triggers the credential access already has credential access related configuration information, and the V-SNPN (the gNB of the V-SNPN) may broadcast ID information of its supporting home SP, using the system information. The UE may determine whether to access a cell by considering the V-SNPN ID broadcast by the V-SNPN gNB in SIB1.

However, in some cases, a UE 1g-05 may not have credential access related configuration information. An SNPN which supports the UE 1g-05 to access the gNB to obtain the credential access related configuration information from a specific server 1g-15 is referred to as an O-SNPN 1g-10. In the disclosure, the access attempted to the O-SNPN to obtain the credential access related configuration information is referred to as an onboarding access.

To support the SNPN, new system information SIB18 is adopted. The SIB18 may include the GIN information mentioned above. In addition, the SIB18 may include indicators indicating whether a cell which broadcasts the SIB18 supports the V-SNPN or the O-SNPN. For example:
extCH-Support-r17 field: indicates whether the corresponding cell supports the credential access the external CH access);
extCH-WithoutConfigAllowed-r17 field: indicates whether the corresponding cell supports the credential access by the UE having no SNPN related configuration;
onboardingEnabled-r17 field: indicates whether the corresponding cell supports the onboarding access; and/or
imsEmergencySupportForSNPN-r17 field: indicates whether the corresponding cell supports an interne protocol (IP) multimedia subsystem (IMS)-emergency call for the SNPN

The disclosure suggests collecting and reporting, at the UE, necessary measurement information for NPN optimization through the logged MDT, cell establishment failure (CEF) report and radio link failure (RLF) report. Together with the new collection information, the disclosure introduces a procedure for performing an NPN checking operation for the collecting or the reporting.

FIG. 1H illustrates a flowchart of operations for collecting and reporting NPN related information, through the logged MDT according to an embodiment of the present disclosure.

A UE 1h-05 may report its capability information to a gNB 1h-10 in operation 1h-13. The capability information may include indicator information indicating that the UE 1h-05 may collect and report necessary measurement information for the NPN optimization through the logged MDT, the CEF report and the RLF report.

The UE 1h-05 may receive a LoggedMeasurementConfiguration message containing logged MDT configuration information from the gNB 1h-10 in operation 1h-15. The UF, 1h-05 may be connected to the gNB 14-10 as the NPN. According to an embodiment of the disclosure, the LoggedMeasurementConfiguration message may include npn-IdentityList and GIN related information.

The npn-IdentityList information is NPN ID (PIN-NPN ID or SNPN ID) list information, and may contain NPN ID information for performing not only the logged MDT hut also the MDT data storing report and the MDT data report.

The GIN related information is GIN list information, and may contain GIN information for performing not only the logged MDT but also the MDT data storing report and the MDT data report. The GIN list may be, but not limited to, a list of PLMN and NID combinations, or a list of GIN index values indicated in the SIB18. If the GIN related information is provided as the list of the GIN index values indicated in the SIB18, the UE 1h-05 may directly find and store a GIN ID (a combination of the PLMN and the NID) corresponding to the GIN index from the received SIB18.

Using the information included in LoggedMeasurementConfiguration, the UE 1h-05 may determine whether to perform the logged MDT, the MDT data storing report and the MDT data report in a specific cell. In so doing, the UE 1h-05 may determine differently depending on whether the cell transmitting the LoggedMeasurementConfiguration message is the PNI-NPN or the SNPN.

According to an embodiment of the disclosure, since the PNI-NPN provides a logical private network via the NPN, an entity which actually optimizes the physical mobile communication network may be the existing mobile communication service provider. Hence, the UE 1h-05 may determine whether to report the MDT data collected through the logged MDT in the specific cell, through plmn-IdentityList information configured by the conventional LoggedMeasurementConfiguration message. That is, if the RPLMN matches at least one of the PLMNs of plmn-Identity-List in the serving cell, the UE 1h-05 receiving the information included in LoggedMeasurementConfiguration may collect MDT measurement results in the corresponding cell or report the collected MDT measurement results.

On the other hand, the mobile communication service provider may want to optimize the network based on the PNI-NPN. Hence, the UE 1h-05 may determine whether to report the MDT data collected through the logged MDT by considering both plmn-IdentityList information and npn-IdentityList information, or by considering only the npn-IdentityList information. Considering both the plmn-IdentityList information and the npn-IdentityList information, if the PLMN supported in the serving cell matches at least one of the PLMNs of plmn-IdentityList and the PNI-NPN selected or registered by the UE matches at least one of the PNI-NPNs of npn-IdentityList, the UE 1h-05 may collect MDT measurement results in the corresponding cell or report the collected MDT measurement results.

By contrast, considering only the npn-IdentityList information, if the PNI-NPN selected or registered by the UE matches at least one of the PNI-NPNs of npn-IdentityList, the UE 1h-05 may collect MDT measurement results in the corresponding cell or report the collected MDT measurement results.

Since the SNPN is the Ovate network separated from the existing mobile communication network, the UE 1h-05 may determine whether to report the MDT data collected through the logged MDT by considering only the npn-IdentityList information. That is, if the SNPN selected or registered by the UE 1h-05 matches at least one of the SNPNs of npn-identity List, the UE 1h-05 may collect MDT measurement results in the corresponding cell or report the collected MDT measurement results. The SNPN has evolved to support the credential access or the onboarding access. Hence, the SNPN may collect the MDT measurement result based on a specific GIN, and for doing so, the gedMeasurementConfiguration message may contain the GIN related information for collecting the MDT measurement results or reporting the collected. MDT measurement results.

Thus, the UE 1h-05 may determine whether to report the MDT data collected through the logged MDT in a specific cell by considering both the npn-IdentityList information and the GIN related information, or by considering only the GIN related information. Considering both the npn-IdentityList information and the GIN related information, if the SNPN selected or registered by the UE 1h-05 matches at least one of the SNPNs of npn-IdentityList and at least one of GINs supported in the corresponding cell matches at least one GIN contained in the GIN related information, the UE 1h-05 may collect MDT measurement results in the corresponding cell or report the collected MDT measurement results.

By contrast, considering only the GN related information, if at least one of the GINs supported in the corresponding cell matches at least one GIN contained in the GIN related information, the UE 1h-05 may collect MDT measurement results in the corresponding cell or report the collected MDT measurement results.

The UE 1h-05 receiving the LoggedMeasurementConfigurati on message may drive a specific timer, that is, a T330 in operation 1h-20. The UE 1h-05 may receive a RRCRelease message from the gNB, and switch to RRC_IDLE or RRC_INACTIVE depending on whether the RRCRelease message includes a suspendConfig IE in operation 1h-30. The UE 1h-05 switching to RRC_IDLE or RRC_INACTIVE may collect and store MDT measurement results, according to the MDT configuration information contained in the LoggedMeasurementConhguration message in operation 1h-35.

Through cell (re)selection, the UE 1h-05 camping on one cell may receive SIB1 broadcast by the cell and NPN related configuration information in SIB18 in operation 1h-40. In this case, based on new MDT configuration information contained in the LoggedMeasurementConfigurab on message, the SIB1, and the information contained in the SIB18, the UE 1h-05 may determine whether to perform the logged MDT in the corresponding cell in operation 1h-45. If storing NPN related measurement results, the UE 1h-05 may store the following new information in operation 1h-50:
whether the corresponding cell supports the external CH access or the onboarding access;
GINs information supported in the corresponding cell, that SIB18 (partial) contents;
ID of the NPN on which the UE is camping, or ID of the NPN selected or registered by the UE (PLMN+CAG ID or PLMN+NID);
GIN information supportable by the UE (list of PLMN+NID combinations), in GINS supported by the corresponding cell; and/or
NPN related indicator information provided by the corresponding cell through SIB1, i.e., extCH-Support-r17, extCH-WithoutConfigAllowed-r17, onboardingEnabled-r17, imsEmergencySupportForSNPN-r17.

Through the conventional logged MDT, the collected information may be stored together. The new information described above may not be stored every log, and may be stored in at least one of logs collected in one serving cell.

The UE 1h-05 may report to the gNB an availability indicator indicating the stored new information in the RRC establishment, RRC resume, RRC reestablishment or RRCReconftguration process in operation 1h-55. Before reporting the availability indicator, the UE 1h-05 may perform PLMN/NPN checking in operation 1h-60.

In the PLMN/NPN checking of the PNI-NPN, considering both the plmn-IdentityList information and the npn-IdentityList information, if the RPLMN matches at least one of the PILMNs of plmn-IdentityList and the PNI-NPN selected or registered by the UE 1h-05 matches at least one of the PNI-NPNs of npn-IdentityList, the UE 1h-05 may report the availability indicator to the corresponding cell. By contrast, considering only the npn-IdentityList information, if the PNI-NPN selected or registered by the UE 1h-05 matches at least one of the PNI-NPNs of npn-IdentityList, the UE 1h-05 may report the availability indicator to the corresponding cell.

In the PLMN/NPN checking of the SNPN, considering both the npn-IdentityList information and the GIN related information, if the SNPN selected or registered by the UE 1h-05 matches at least one of the SNPNs of npn-IdentityList and at least one of the GINs supported in the corresponding cell matches at least one GIN contained in the GIN related information, the UE 1h-05 may report the availability indicator to the corresponding cell. By contrast, considering only the GIN related information, if at least one of the GINS supported in the corresponding cell matches at least one GIN contained in the GIN related information, the UE 1h-05 may report the availability indicator to the corresponding cell.

The availability indicator may be contained in the RRCSetupComplete message, the RRCResumeComplete message, the RRCReestablishmentComplete message or the RRCReconfigurationComplete message and reported to the gNB 1h-10 in operation 1h-65.

The gNB 1h-10 receiving the availability indicator may request the MDT measurement results stored in the UE 1h-05 using a UEInformationRequest message in operation 1h-70. The UE 1h-05 receiving the MDT measurement result request may report its stored MDT measurement results to the gNB 1h-10 using a UEInformationResponse message in operation 1h-75 operation.

FIG. 11 illustrates a flowchart of UE operations for collecting and reporting the NPN related information, through the logged MDT according to an embodiment of the present disclosure.

In operation 1i-05, the UE may receive the LoggedMeasurementConfiguration message from the gNB. The LoggedMeasurementConfiguration message may include configuration information required to collect and report the NPN related information.

In operation 1i-10, the UE may receive the RRCRelease message, and switch to the idle mode or the inactive mode.

In operation 1i-15, the UE may perform the logged MDT operation according to the configuration information received in the LoggedMeasurementConfiguration message.

In operation 1i-20, if satisfying a specific condition, the UE may collect and store the NPN related information. According to an embodiment of the disclosure, if satisfying the specific condition by performing the logged MDT operation, the UE may collect the NPN related information, and store the collected NPN related information as the MDT measurement result.

In operation 1i-25, the UE may switch to the connected mode through the RRC (re)establishment or RRC resume process. The UE may report the indicator indicating the presence of the stored MDT measurement result to the gNB, during the RRC (re)establishment or RRC resume process.

In operation 1i-30, the UE may receive the MDT measurement result report request from the gNB.

In operation 1i-35, the UE may report its stored MDT measurement result to the gNB.

FIG. 1J illustrates a flowchart of gNB operations for collecting and reporting the NPN related information, through the logged MDT according to an embodiment of the present disclosure.

In operation 1j-05, the gNB may transmit the LoggedMeasurementConfiguration message to the UE. The LoggedMeasurementConfiguration message may include npn-IdentityList and the GIN related information.

In operation 1j-10, the gNB may transmit the RRCRelease message to the UE.

In operation j-15, the gNB may receive a specific RRC message including the availability indicator from the UE.

In operation 1j-20, the gNB may request the UE to report the stored MDT measurement result, using the UEInformationRequest message.

In operation 1j-25, the gNB may receive from the UE the UElnformationResponse message including the MDT measurement result.

FIG. 1K illustrates a flowchart of operations for collecting and reporting the NPN related information, through the CEF report according to an embodiment of the present disclosure.

A UE 1k-05 wishing to access the NPN may receive SIB1 and SIB18 broadcast from a gNB 1k-10 in operation 1k-15. Through SIB1 and SIB18, the UE 1k-05 may attempt the NPN access to the gNB 1k-10. In so doing, the UE 1k-05 transmits the RRCSetupRequest or RRCResumeRequest message to the gNB 1k-10 in operation 1k-20. If transmitting the RRCSetupRequest or RRCResumeRequest message, the UE 1k-05 may drive a T300 (for RRCSeupRequest transmission) or T319 (for RRCResumeRequest transmission) timer in operation 1k-25. If not successfully accessing the gNB 1k-10 until the T300 or the T319 timer expires, the UE 1k-05 may regard the NPN access attempt as RRC setup failure or RRC resume failure.

In this case, the UE 1k-05 may store CEF report contents in operation 1k-35. The disclosure suggests new NPN related information as follows, as the CEF report content in operation 1k-40:
ID of the NPN to which the UE attempts to access (PNI-NPN ID (PLMN+CAG ID) or SNPN ID (PLMN+NID)). The ID of the NPN is selected by UE non-access stratum (NAS). In the CEF report, information may be used for the NPN checking;
GIN information (PLMN+NID) to which the UE attempts to access. The GIN information is selected by UE NAS. In the CEF report, the GIN information (PLMN+NID) to which the UE 1k-05 attempts to access may be used for the NPN checking;
whether the corresponding access is for connection to an NPN cell;
whether the corresponding access is for connection to a PNI-NPN cell or an SNPN cell;
whether the corresponding access is the external CH access or the onboarding access;
GIN information (list of PLMN+NID combinations) supportable by the UE 1k-05, in GINs supported by the corresponding cell;
GINs information supported in the corresponding cell, that is, SIB18 (partial) contents; and/or
NPN related indicator information provided by the corresponding cell through SIB1, i.e., extCH-Support-r17, extCH-WithoutConfigAllowed-r17, onboardingEnabled-r17, imsEmergencySupport-r17.

According to an embodiment of the disclosure, the UE 1k-05 may store information as the conventional CEF report content together. For example, in the PNI-NPN access, the UE 1k-05 may store the PLMN value selected by the UE NAS.

The UE 1k-05 may report to the gNB the availability indicator indicating the stored CEF report in the RRC establishment, RRC resume, RRC reestablishment or RRCReconfiguration procedure in operation 1h-45. Before reporting the availability indicator, the UE 1k-05 may perform the PLMN/NPN checking in operation 1k-50.

In the PLMN/NPN checking of the PN1-NPN, considering both the PLMN and the PN1-NPN stored in the CEF report content, if the RPLMN matches the stored PLMN and the PNI-NPN selected or registered by the UE 1k-05 matches the stored PNI-NPN, the UE 1k-05 may report the availability indicator to the corresponding cell. By contrast, considering only the stored PNI-NPN, if the PNI-NPN selected or registered by the UE 1k-05 matches the stored PNI-NPN, the UE 1k-05 may report the availability indicator to the corresponding cell.

In the PLMN/NPN checking of the SNPN, considering both the SNPN and the GIN information (i.e., the GIN to which the 1k-05 attempts to access) stored in the CEF report content, if the SNPN selected or registered by the UE 1k-05 matches the stored SNPN and at least one of the GINs supported in the corresponding cell (or the GIN selected by the UE 1k-05) matches the stored GIN, the UE 1k-05 may report the availability indicator to the corresponding cell. By contrast, considering only the GIN related information, if at least one of the GINs supported in the corresponding cell (or the GIN selected by the UE 1k-05) matches the stored GIN, the UE 1k-05 may report the availability indicator to the corresponding cell.

The availability indicator may be contained in the RRCSetupComplete message, the RRCResumeComplete message, the RRCReestablishmentComplete message or the RRCReconfigurationComplete message and reported to the gNB 1k-10 in operation 1h-55.

The gNB 1k-10 receiving the availability indicator may request the CEF report stored in the UE 1k-05 using the UEInformationRequest message in operation 1k-60. The UE 15-05 receiving the CEF report request may report its stored CEF report to the gNB 1k-10 using the UEInformationResponse message in operation 1k-65.

FIG. 1L illustrates a flowchart of UE operations for collecting and reporting the NPN related information, through the CEF report according to an embodiment of the present disclosure.

In operation IL-05, the UE may transmit the RRCSetupRequest or RRCResumeRequest message to the gNB for the NPN access. In so doing, the T300 or T319 timer may operate.

In operation 1L-10, the UE may recognize that the T300 or T319 timer expires.

In operation IL-15, the UE may configure the CEF report content.

In operation IL-20, the UE may store the NPN related information, as the CEF report content.

In operation IL-25, the UE may switch to the connected mode through the RRC (re)establishment or RRC resume procedure. The UE may report the indicator indicating the stored CEF report to the gNB.

In operation IL-30, the UE may receive the CEF report request from the gNB.

In operation IL-35, the UE may report its stored CEF report to the gNB.

FIG. 1M illustrates a flowchart of operations for collecting and reporting the NPN related information, through the RLF report according to an embodiment of the present disclosure.

Referring to FIG. 1M, a UE 1m-05 may be NPN connected to a gNB 1m-10 in operation 1m-15. The UE 1m-05 may recognize radio link failure or handover failure (HOF) in operation 1m-20. In this case, the UE 1m-05 may store RLF report contents in operation 1m-25. The disclosure may suggest new NPN related information as the RLF report content as below in operation 1m-30:
ID of the NPN to which the UE 1m-05 is connected (PNI-NPN ID (PLMN+CAG ID) or SNPN ID (PLMN+NID)). The ID of the NPN is selected by the UE NAS. The ID of the NPN to which the UE 1m-05 is connected may be used for the NPN checking, in the CEF report;
GIN information (PLMN+NID) to which the UE 1m-05 is connected. The GIN information is selected by the UE NAS. In the CEF report, the GIN information to which the UE 1m-05 is connected may be used for the NPN checking;
whether the corresponding access is connection to the NPN cell;
whether the corresponding access is connection to the PNI-NPN cell or the SNPN cell;
whether the corresponding access is the external CH access or the onboarding access;
GIN information (list of PLMN+NID combinations) supportable by the UE 1m-05, in GINs supported by the corresponding cell;
GINs information supported in the corresponding cell, that is, SIB18 (partial) contents; and/or
NPN related indicator information provided by the corresponding cell through SIB1, i.e., extCH-Support-r17, extCH-WithoutConfigAllowed-r17, onboardingEnabled-r17, imsEmergencySupportForSNPN-r17.

According to an embodiment of the disclosure, the UE may store the collected information together as the existing REF report content. For example, the PNI-NPN access may store the PLMN value selected by the UE NAS.

The UE 1m-05 may report to the gNB the availability indicator indicating the stored RLF report in the RRC establishment, RRC resume, RRC reestablishment or RRCReconfiguration in operation 1m-35. Before reporting the availability indicator, the UE 1m-05 may perform the PLMN/NPN checking in operation 1m-40.

In the PLMN/NPN checking of the PNI-NPN, considering both the PLMN and the PNI-NPN stored in the RLF report content, if the RPLMN matches the stored PLMN and the PNI-NPN selected or registered by the UE 1m-05 matches the stored PNI-NPN, the UE 1m-05 may report the availability indicator to the corresponding cell. By contrast, considering only the stored PNI-NPN, if the PNI-NPN selected or registered by the UE 1m-05 matches the stored PNI-NPN, the UE 1m-05 may report the availability indicator to the corresponding cell.

In the PLMN/NPN checking of the SNPN, considering bath the SNPN and the GIN information (i.e., the GIN to which the UE 1m-05 attempts to access) stored in the RLF report content, if the SNPN selected or registered by the UE lm-05 matches the stored SNPN and at least one of the GINs supported in the corresponding cell (or the GIN selected by the UE 1m-05) matches the stored GIN, the UE 1m-05 may report the availability indicator to the corresponding cell. By contrast, considering only the GIN related information, if at least one of the GIN supported in the corresponding cell (or the GIN selected by the UE 1m-05) matches the stored GIN, the UE 1m-05 may report the availability indicator to the corresponding cell.

The availability indicator may be contained in the RRCSetupComplete message, the RRCResumeComplete message, the RRCReestablishmentComplete message or the RRCReconfigurationComplete message and reported to the gNB 1m-10 in operation 1m-45.

The gNB 1m-10 receiving the availability indicator may request the RLF report stored in the UE 1m-05 using the UEInformationRequest message in operation 1m-50. The UE 1m-05 receiving the RLF report request may report its stored RLF report to the gNB 1m-10 using the UEInformationResponse message in operation 1m-55.

FIG. 1N illustrates a flowchart of UE operations for collecting and reporting the NPN related information, through the RLF report according to an embodiment of the present disclosure.

In operation 1n-05, the UE may be NPN connected to the gNB.

In operation 1n-10, the UE may recognize the RLF or the HOF.

In operation 1n-15, the UE may configure the RLF report content.

In operation 1n-20, the UE may store the NPN related information, as the RLF report content.

In operation 1n-25, the UE may switch to the connected mode through the RRC (re)establishment or RRC resume process. In the RRC (re)establishment or RRC resume process, the UE may report the indicator indicating the stored RLF report to the gNB.

In operation 1n-30, the UE may receive the RLF report request from the gNB.

In operation 1n-35, the UE may report its stored RLF report to the gNB.

FIG. 1O illustrates a block diagram of an internal structure of a terminal according to an embodiment of the present disclosure.

Referring to FIG. 1O, the UE may include a radio frequency (RF) processor 1o-10, a baseband processor 1o-20, a storage 1o-30, arid a controller 1o-40. The UE is not limited to the example, and may include less or more components than those shown in FIG. 1O.

The RF processor 1o-10 may perform a function for transmitting and receiving a signal over a radio ireless channel, such as signal band conversion and amplification. That is, the RF processor 1o-10 may up-convert a baseband signal provided from the baseband processor 1o-20 into an RF band signal, transmit the RF band signal via an antenna, and down-convert an RF band signal received through the antenna into a base-band signal. For example, the RF processor 1o-10 may include, but not limited to, a transmit filter, a receive filter, an amplifier, a mixer, an oscillator, a digital to analog converter (DAC), an analog to digital converter (ADC), and so forth. Although only one antenna is illustrated in FIG. 1O, the terminal may include a plurality of antennas. The RF processor 1o-10 may include a plurality of RF chains. Further, the RF processor 1o-10 may perform beamforming. For the beamforming, the RF processor 1o-10 may adjust phases and magnitudes of signals transmitted and received via the plurality of the antennas or antenna elements. The RF processor 1o-10 may perform MIMO, and receive several layers in performing MIMO operations.

The baseband processor 1o-20 may perform a conversion function between a baseband signal and a bitstream according to a physical layer standard of the system. For example, in data transmission, the baseband processor 1o-20 may generate complex symbols by encoding and modulating a transmit bitstream. In data reception, the baseband processor 1o-20 may restore a received bitstream by demodulating and decoding the baseband signal provided from the RF processor 1o-10. For example, according to the OFDM, in the data transmission, the baseband processor 1o-20 may generate complex symbols by encoding and modulating a transmit bitstream, map the complex symbols to subcarriers, and construct OFDM symbols through inverse fast Fourier transform (IFFT) and cyclic prefix (CP) insertion. Also, in the data reception, the baseband processor 1o-20 may divide the baseband signal provided from the RF processor 1o-10 into OFDM symbols, recover signals mapped to the subcarriers through FFT, and recover the received bitstream by demodulation and decoding the signals.

The baseband processor 1o-20 and the RF processor 1o-10 may transmit and receive the signal as described above. Accordingly, the baseband processor 1o-20 and the RF processor 1o-10 may be referred to as a transmitter, a receiver, a transceiver, or a communicator. Further, at least one of the baseband processor 1o-20 or the RF processor 1o-10 may include a plurality of communication modules for supporting a plurality of different RATs. In addition, at least one of the baseband processor 1o-20 and the RF processor 1o-10 may include a plurality of communication modules for processing signals in different frequency bands. For example, the different RAfs may include a wireless local area network (LAN) (e.g., IEEE 802.11), a cellular network (e.g., LTE), and the like. In addition, the different frequency bands may include a super high frequency (SHF, e.g., 2.5 GHz, 5 GHz) band, and a millimeter wave (mmWave) (e.g., 60 GHz) band. The terminal may transmit and receive a signal to and from the base station using the baseband processor 1o-20 and the RF processor 1o-10, and the signal may include control information and data.

The storage 1o-30 may store data such as a basic program for operations of the terminal, an application program, and configuration information. In particular, the storage 1o-30 may store information related to a second access node which performs wireless communication using a second RAF. The storage 1o-30 may provide the stored data at a request of the controller 1o-40. The storage 1o-30 may include a storage medium such as a read only memory (ROM), a random access memory (RAM), a hard disc, a compact disc (CD)-ROM and a digital versatile disc (DVD) or a combination of storage media. In addition, the storage 1o-30 may include a plurality of memories. According to some embodiment, the storage 1o-30 may store a program for executing the method for optimizing the NPN according to the disclosure.

The controller 1o-40 may control general operations of the terminal. For example, the controller 1o-40 may transmit and receive a signal through the baseband processor 1o-20 and the RF processor 1o-10. The controller 1o-40 records and reads data in and from the storage 1o-30. For doing so, the controller 1o-40 may include at least one processor. For example, the controller 1o-40 may include a communication processor (CP) for performing communication control and an application processor (AP) for controlling a higher layer such as an application program. In addition, at least one configuration of the terminal may be implemented with a single chip.

FIG. IP illustrates a configuration of the base station according to the present disclosure.

As shown in FIG. 1P, the base station includes an RF processor 1p-10, a baseband processor 1p-20, a backhaul communicator 1p-30, a storage 1p-40, and a controller 1p-50. The base station is not limited to the example, and may include less or more components than those shown in FIG. 1P. In addition, the network entity (or a network function) may be identical to or correspond to the base station.

The RF processor 1p-10 may perform a function for transmitting and receiving a signal over a radio channel, such as band conversion and amplification. That is, the RF processor 1p-10 may up-convert a baseband signal provided from the baseband processor 1p-20 into an RF band signal, transmits the RF band signal via an antenna and down-convert an RF band signal received through the antenna into a baseband signal. For example, the RF processor 1p-10 may include a transmit filter, a receive fitter, an amplifier, a mixer, an oscillator, a DAC, an ADC, and so forth. Although only one antenna is illustrated in FIG. 1P, the base station may also include a plurality of antennas. The RF processor 1p-10 may include a plurality of RF chains. Further, the processor 1p-10 may perform the beamforming. For the beamforming, the RF processor 1p-10 may adjust phases and magnitudes of signals transmitted and received through the plurality of the antennas or antenna elements. The RF processor 1p-10 may perform DL MIIMO operations by transmitting one or more layers.

The baseband processor 1p-20 may perform a conversion function between a baseband signal and a bitstream according to a physical layer standard of a first RAT. For example, in the data transmission, the baseband processor 1p-20 may generate complex symbols by encoding and modulating a transmit bitstream. In the data reception, the baseband processor 1p-20 may restore a received bitstream by demodulating and decoding the baseband signal provided from the RF processor 1p-10. For example, according to the OFDM, in the data transmission, the baseband processor 1p-20 may generate complex symbols by encoding and modulating a transmit bitstream, map the complex symbols to subcarriers, and construct OFDM symbols through the IFFT and the CP insertion. Also, in the data reception, the baseband processor 1p-20 may divide the baseball signal provided from the RF processor 1p-10 into OFDM symbols, restore signals mapped to the subcarriers through the FFT, and restore the received bitstream by demodulation and decoding the signals. The baseband processor 1p-20 and the RF processor 1p-10 may transmit and receive the signal as described above.

Hence, the baseband processor 1p-20 and the RF processor 1p-10 may be referred to as a transmitter, a receiver, a transceiver, a communicator, or a wireless communicator. The base station may transmit and receive the signal to and from the terminal using the baseband processor 1p-20 and the RF processor 1p-10, and the signal may include control information and data.

The backhaul communicator 1p-30 may provide an interface for communicating with other nodes in the network. That is, the backhaul communicator 1p-30 may convert a bitstream transmitted to another node, for example, an auxiliary base station, a core network, and so on, into a physical signal, and convert a physical signal received from another node into a bitstream. The backhaul communicator 1p-30 may be included in the communication unit.

The storage 1p-40 may store data such as a basic program for operations of the base station, an application program, and configuration information. In particular, the storage 1p-40 may store information of the bearer allocated to the connected terminal, and the measurement result reported from the connected terminal. The storage 1p-40 may store information used to determine whether to provide or stop multiple connections to the terminal. The storage 1p-40 may provide the stored data at a request of the controller 1p-50. The storage 1p-40 may include a storage medium such as a ROM, a RAM, a hard disc, a CD-ROM and a DVD or a combination of storage media. In addition, the storage 1p-40 may include a plurality of memories. According to some embodiment, the storage 1p-40 may store a program for executing the method for optimizing the NPN according to the disclosure.

The controller 1p-50 may control general operations of the base station. For example, the controller 1p-50 may transmit and receive a signal through the baseband processor 1p-20 and the RF processor 1p-10 or the backhaul communicator 1p-30, The controller 1p-50 records and reads data in and from the storage 1p-40. For doing so, the controller 1p-50 may include at least one processor. In addition, at least one configuration of the base station may be implemented with a single chip.

The disclosure provides a method for reporting an MDT measurement result of a terminal, the method including receiving from a base station configuration information required to collect and report NPN related information, performing logged MDT based on the configuration information, in an idle mode or an inactive mode, storing a MDT measurement result, based on the logged MDT, if switching to an RRC connected state, transmitting to the base station an indicator indicating the MDT measurement result stored, receiving a report request of the MDT measurement result from the base station and reporting the MDT measurement result to the base station.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a CD-ROM, DVDs or other optical storage device, and a magnetic cassette. Alternatively, it may be stored to a memory combining part or all of those recording media. A plurality of memories may be included.

Also, the program may be stored in an attachable storage device accessible via a communication network such as internet, intranet, LAN, wide LAN (WLAN), or storage area network (SAN), or a communication network by combining these networks. Such a storage device may access a device which executes an embodiment of the disclosure through an external port. in addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a provided situation for the convenience of explanation, the disclosure is not limited to a single component or a plurality of components, the components expressed in the plural form may be configured as a single component, and the components expressed in the singular form may be configured as a plurality of components.

While the particular embodiments of the disclosure have been particularly described, it will be understood by one of ordinary skill in the art that various changes in form and details may be made therein without departing from the spirit and scope of the disclosure. Hence, the scope of the disclosure is not defined by the embodiments of the disclosure but by the claims and all modifications or alternatives derived from the scope and spirit of the claims and equivalents thereof fall within the scope of the disclosure. That is, it will be obvious to one of ordinary skill in the art that various modifications may be made based on the technical scope of the disclosure. Also, the embodiments of the disclosure may be combined if necessary. For example, some of methods provided by the disclosure may be combined with each other to operate the gNB and the UE. Also, although the embodiments of the disclosure are suggested based on the 5G and NR systems, other modifications based on the technical scope of the embodiments of the disclosure may be applied to other communication systems such as LTE, LTE-A, and LTE-A-Pro systems.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication system, the method comprising:
receiving logged minimization of drive test (MDT) configuration information including a list of at least one non-public network (NPN) identity;
performing a logged MDT for a stand-alone NPN (SNPN) based on the logged MDT configuration information;
identifying whether an identity of the SNPN selected or registered by the UE matches with the list of the at least one NPN identity;
transmitting, to a base station (BS), an availability indicator indicating that a result of the logged MDT is stored in the UF, in case that the identity of the SNPN selected or registered by the UE matches with the list of the at least one NPN identity;
receiving, from the BS, a UE information request message; and
transmitting, to the BS, a UE information response message including the result of the logged MDT for the SNPN as a response to the UE information request message.

2. The method of claim 1, wherein the result of the logged MDT includes the identity of the SNPN in which the UE is camping-on or selected, or registered by the UE.

3. The method of claim 1, wherein performing the logged MDT further comprises:
identifying whether a radio link failure (RLF) has occurred,
wherein the UE information request message includes a RLF report request message,
wherein the UE information response message includes a RLF report, and
wherein the RLF report includes the identity of the SNPN in which the UE is camping-on or selected, or registered by the UE.

4. The method of claim 1. further comprising:
transmitting, to the BS, UE capability information including information for indicating that the UE reports at least one of a logged MDT report or a radio link failure (RLF) report.

5. The method of claim 2, wherein the logged MDT configuration information further includes group identifiers (IDs) for network selection (GIN) information, and
wherein the UE information response message further includes at least one result of the logged MDT collected based on the GIN information.

6. A method performed by a base station (BS) in a wireless communication system, the method comprising:
receiving, from a user equipment (UE), an availability indicator indicating that a result of logged MDT is stored in the UE, in case that an identity of a stand-alone non-public network (SNPN) associated with the BS matches with a list of at least one non-public network (NPN) identity configured for the UE;
transmitting, to the UE, a UE information request message based on the availability indicator; and
receiving, from the UE, a UE information response message including the result of the logged MDT for the SNPN as a response to the UE information request message.

7. The method of claim 6, wherein the result of the logged MDT includes an identity of the SNPN in which the UE is camping-on or selected, or registered by the UE.

8. The method of claim 6, wherein the UE information request message includes a radio link failure (RLF) report request message,
wherein the UE information response message includes a RLF report, and
wherein the RLF report includes an identity of the SNPN in which the UE is camping-on or selected, or registered by the UE.

9. The method of claim 6, further comprising:
receiving, from the UE, UE capability information including information for indicating that the UE reports at least one of a logged MDT report or a radio link failure (RLF) report.

10. The method of claim 7, wherein the UE information response message further includes at least one result of the logged MDT collected based on group identifiers (IDs) for network selection (GIN) information, and
wherein the GIN information is included in logged MDT configuration information using for performing the logged MDT, by the UE.

11. A user equipment (UE) in a wireless communication system, the UE comprising:
a transceiver, and
a controller coupled with the transceiver and configured to:
receive logged minimization of drive test (MDT) configuration information including a list of at least one non-public network (NPN) identity;
perform a logged MDT for a stand-alone NPN (SNPN) based on the logged MDT configuration information;
identify whether an identity of the SNPN selected or registered by the UE matches with the list of the at least one NPN identity;
transmit, to a base station (BS), an availability indicator indicating a result of the logged MDT is stored in the UE, in case that the identity of the SNPN selected or registered by the FE matches with the list of the at least one NPN identity;
receive, from the BS, a UE information request message; and
transmit, to the BS, a UE information response message including the result of the logged MDT for the SNPN as a response to the UE information request message.

12. The UE of claim 11, wherein the result of the logged MDT includes the identity of the SNPN in which the UE is camping-on or selected, or registered by the FE.

13. The UE of claim 11, wherein the controller is further configured to:
identify whether a radio link failure (RLF) has occurred,
wherein the UE information request message includes a RLF report request message,
wherein the UE information response message includes a RLF report, and
wherein the RLF report includes the identity of the SNPN in which the UE is camping-on or selected, or registered by the UE.

14. The UE of claim 11, wherein the controller is further configured to:
transmit, to the BS, UE capability information including information for indicating that the UE reports at least one of a logged MDT report or a radio link failure (RLF) report.

15. The UE of claim 12, wherein the logged MDT configuration information further includes group identifiers (IDs) for network selection (GIN) information, and
wherein the UE information response message further includes at least one result of the logged MDT collected based on the GIN information.

16. A base station (BS) in a wireless communication system, the BS comprising:
a transceiver, and
a controller coupled with the transceiver and configured to:
receive, from a user equipment (UE), an availability indicator indicating that a result of logged MDT is stored in the UE, in case that an identity of a stand-alone non-public network (SNPN) associated with the BS matches with a list of at least one non-public network (NPN) identity configured for the UE;
transmit, to the UE, a UE information request message based on the availability indicator; and
receive, from the UE, a UE information response message including the result of the logged MDT for the SNPN as a response to the UE information request message.

17. The BS of claim 16, wherein the result of the logged MDT includes an identity of the SNPN in which the UE is camping-on or selected, or registered by the UE.

18. The BS of claim 16, wherein the UE information request message includes a radio link failure (RLF) report request message,
wherein the UE information response message includes a RLF report, and
wherein the RLF report includes an identity of the SNPN in which the UE is camping-on or selected, or registered by the UE.

19. The BS of claim 16, wherein the controller is further configured to:
receive, from the UE, UE capability information including information for indicating that the UE reports at least one of a logged MDT report or a radio link failure (RLF) report.

20. The BS of claim 17, wherein the UE information response message further includes at least one result of the logged MDT collected based on group identifiers (IDs) for network selection (GIN) information, and
Wherein the GIN information is included in logged MDT configuration information using for performing the logged MDT, by the UE.
